(19) United States
(12) Patent Application Publication
(10) Pub. No.: US 2026/0214194 A1
(43) Pub. Date: Jul. 23, 2026

(54) METHOD FOR DISPLAYING A STEREOSCOPIC IMAGE ON AN AUTOSTEREOSCOPIC DISPLAY DEVICE

(71) Applicant: Dimenco Holding B.V., Veldhoven (NL)

(72) Inventors: Jurjen Caarls, Eindhoven (NL); Pieter Wilhelmus Theodorus de Jong, Hertogenbosch (NL)

(21) Appl. No.: 19/136,629

(22) PCT Filed: Dec. 8, 2023
(86) PCT No.: PCT/NL2023/050644

§ 371 Date: Jun. 6, 2025

(30) Foreign Application Priority Data
Dec. 8, 2022 (NL) 2033691

(51) Int. Cl. H04N 13/117; G02B 30/27; G09G 3/00; H04N 13/305; H04N 13/376; H04N 13/385

(52) U.S. Cl. CPC H04N 13/117; G02B 30/27; G09G 3/001; H04N 13/305; H04N 13/376; H04N 13/385; G09G 2310/08; G09G 2320/0261

(57) ABSTRACT

The invention relates to a method for displaying to a viewer of an autostereoscopic display device a stereoscopic image of a 3D-scene, wherein rendering of the stereoscopic image takes into account the viewing position of the viewer relative to the autostereoscopic display device, so that the viewer is allowed to experience the 3D-scene with a perspective that corresponds to his viewing position relative to the 3D-scene. In the method of the invention, the rendering is performed on the center of the eyeballs rather than on the pupils. This makes that saccadic movement of the eyes of the viewer is by-passed and does not play a role in the image rendering, thereby solving the problem that saccadic movement is too fast to be taken account of in a timely manner, because of system latency. The method of the invention effects that a viewer experiences the intended stereoscopic image in a correct manner, also immediately after a saccadic movement of the eyes. The invention also relates to an autostereoscopic display device configured to perform such method.

### FIELD OF THE INVENTION

The invention relates to a method for displaying to a viewer of an autostereoscopic display device a stereoscopic image of a 3D-scene. The invention further relates to an autostereoscopic display device for displaying to a viewer thereof a stereoscopic image of a 3D-scene.

### BACKGROUND

Autostereoscopic displays are playing an increasingly important role in virtual reality and augmented reality applications. One of their most outstanding features is that they allow a viewer to perceive three-dimensional images without a dedicated eyewear device or other wearables, also when the viewer moves relative to the display.

Key to this technology is the presence of an eye tracker in combination with a screen that comprises a lenticular lens or a parallax barrier. This enables that the autostereoscopic display simultaneously directs a left eye image to a left eye of the viewer and a right eye image to a right eye of the viewer. The resulting stereoscopic image provides a depth perception wherein elements in the image may appear in front of the display or further away than the display (‘behind’ the display).

Just as virtually any electronic device that functions through the input of data it acquires, an autostereoscopic display system suffers from latency. This is commonly understood as a time delay between user input and system response, also known as input lag. In the setting of an autostereoscopic display system, this basically means that there is a delay between movement of the viewer's head/eye (user input) and adaptations to displayed content in response thereto (system response). Latency then manifests as incorrect rendering of stereoscopic images. It may also cause crosstalk when a left eye image is for a part also directed at a right eye of the viewer, and vice versa. If latency exceeds a critical threshold, user performance and experience get impaired. This usually concerns a disturbed look around effect and/or crosstalk. For example, a displayed object is not perceived at the correct position, at least temporarily.

Latency in autostereoscopic displays is typically combatted by extrapolating historic position data of the viewer's pupils to obtain estimates of future values (the extrapolation may also include data on the velocity and acceleration). These predictions are used in the rendering of stereoscopic images, so that fast movements of a user's head in a field of view of an autostereoscopic display can timely be accounted for (latency compensation) and do not, or to a lesser extent, lead to an incorrect rendering.

Besides movement of a user's head as a whole, pupils themselves may also move relative to the autostereoscopic display (e.g. when the head is still). This concerns rotational movement of the eyeballs. In certain cases, this movement is very fast, which is known as a saccade. It is such saccades that cause problems with compensating latency, because the saccadic motion is typically already finished before the system can react to it. Also, such a sudden movement is not following any head movement model that is typically used for extrapolating past pupil positions into the future. For example, typical latencies that need to be compensated for are in the range of 60-130 ms, so an estimate of the position of the pupils at a time of 60-130 ms in the future is needed, while saccades typically occur within 20-60 ms. Saccades are therefore either missed in their entirety or cause errors in pupil position prediction when captured by the eye tracker as the extreme speed of the eyes that is measured during a saccade may lead to unrealistic predictions. For example, pupil position movement is extrapolated as if it would be a long lasting movement, which causes overshoots and jitter in their position.

Although one may consider that eye rotation results in a small pupil displacement, especially relative to the freedom of movement of the head as a whole, it is not insignificant. Eye rotation alone appears to cause a noticeable incorrect rendering when it is not accounted for. This is in particular the case when a displayed object is supposed to be in an alignment with real world objects, for example when a virtual object rests on a stationary real world object. When the eyes of a viewer make a saccadic movement relative to such composition that is not timely accounted for by the eye tracker, he will notice that the virtual object makes some movement (small but noticeable) relative to the stationary real world object, while it is of course supposed to be stationary too. The effect is most noticeable for virtual objects that appear close to the viewer's eyes. Also, crosstalk may be perceived by a viewer whose eyes perform saccades, when light intended for a left eye hits a right eye after a right eye saccade, and vice versa.

It is thus necessary to combat the effects of saccades in the latency compensation of the system. To date, however, no satisfactory solution has been found to do so.

### SUMMARY OF THE INVENTION

It is therefore an object of the present invention to find a solution to the problem of incorrect stereoscopic image rendering as a result of saccades; and to the problem of perceived crosstalk as a result of saccades. It is also an object to reduce or even cancel incorrect image display as a result of the latency of an autostereoscopic display device, in particular incorrect image display that is characterized by a wrong 3D-scene position with respect to the real world. It is more generally an object of the present invention to improve the viewing experience of a viewer of an autostereoscopic display device, which includes improving the viewer's perception of the position of a 3D-scene relative to the real world.

It has now been found that one or more of these objects can be reached by performing the eye tracking in a different way.

Accordingly, the present invention relates to a method for displaying to a viewer of an autostereoscopic display device a stereoscopic image of a 3D-scene, the stereoscopic image being displayed by the autostereoscopic display device and being composed of a left eye image to be viewed by a left eye of the viewer and a right eye image to be viewed by a right eye of the viewer; the method comprising
providing 3D-scene data representing the 3D-scene;
rendering the stereoscopic image from the 3D-scene data, taking into account the viewing position of the viewer relative to the autostereoscopic display device, so that the viewer is allowed to experience the 3D-scene with a perspective that corresponds to his viewing position relative to the 3D-scene, wherein the method further comprises
defining a position of a left rendering spot in a left eyeball of the viewer relative to the autostereoscopic display device;
defining a position of a right rendering spot in a right eyeball of the viewer relative to the autostereoscopic display device;
the left rendering spot as well as the right rendering spot having a fixed position with respect to the viewer's head as a whole and being located at a center of rotation of their respective eyeball, or at a distance therefrom of 8.0 mm or less;
using the position of the left rendering spot relative to the autostereoscopic display device and the position of the right rendering spot relative to the autostereoscopic display device for rendering the stereoscopic image from the 3D-scene data;
displaying the rendered stereoscopic image.

The invention further relates to an autostereoscopic display device for displaying to a viewer a stereoscopic image of a 3D-scene, the stereoscopic image being composed of a left image to be viewed by a left eye of the viewer and a right image to be viewed by a right eye of the viewer, the autostereoscopic display device comprising
a left rendering spot and right rendering spot tracking system configured to track
   a position of a left rendering spot in a left eyeball of the viewer relative to the autostereoscopic display device;
   a position of a right rendering spot in a right eyeball of the viewer relative to the autostereoscopic display device;
      the left rendering spot as well as the right rendering spot having a fixed position with respect to the viewer's head as a whole and being located at a center of rotation of their respective eyeball, or at a distance therefrom of 8.0 mm or less;
a display portion, such as a screen, configured to display a left eye image to be viewed by a left eye of the viewer and a right eye image to be viewed by a right eye of the viewer, the display portion comprising
   an array of display pixel elements for producing a display output; and
   a lenticular device provided over the array wherein the lenticular device comprises lenticular lens areas which are capable of directing the display output from different display pixel elements to different spatial positions within a field of view of the autostereoscopic display device to allow a display of a stereoscopic image that is composed of a left eye image and a right eye image;
a rendering module configured to render a stereoscopic image from 3D-scene data, taking into account the viewing position of the viewer relative to the autostereoscopic display device, so that the viewer is allowed to experience the 3D-scene with a perspective that corresponds to his viewing position relative to the 3D-scene;
   wherein the rendering module is further configured to use the position of the left rendering spot relative to the autostereoscopic display device and the position of the right rendering spot relative to the autostereoscopic display device for rendering the stereoscopic image.

### BRIEF DESCRIPTION OF THE DRAWINGS

FIG. 1 schematically displays a sequence of top views of a setting wherein an image is rendered according to a conventional method.

FIG. 2 schematically displays a sequence of top views of a setting wherein an image is rendered according to a method of the invention.

FIG. 3 is a visual representation of events occurring in the real world along an eyeball timeline reflecting eyeball orientations and a display timeline reflecting a lagging image display as a result of latency.

### DETAILED DESCRIPTION OF THE INVENTION

The figures do not limit the present invention to the specific embodiments disclosed therein and described in the present description. Elements in the figures are illustrated for simplicity and clarity and have not necessarily been drawn to scale, emphasis instead being placed upon clearly illustrating the principles of the invention. For example, the relative dimensions of a screen of an autostereoscopic display device, a virtual object presented by the screen and an eyeball perceiving the virtual objects cannot be derived from the figures.

In the context of the invention, by the term “viewer” is meant a person in the real world who can consume, in particular view, content presented by an autostereoscopic display device. Throughout the text, references to the viewer will be made by male words like “he”, “him” or “his”. This is only for the purpose of clarity and conciseness, as it is understood that female words like “she”, and “her” equally apply.

Throughout the text, the term “3D” is used for the sake of conciseness. This term is meant to be equivalent to the term “three-dimensional”. For example, the terms “3D-scene” and “3D-object” are meant to indicate “three-dimensional scene” and “three-dimensional object”, respectively.

In the context of the invention, by “rendering” is meant creating or deriving, with the use of calculations, a left eye image and a right eye image from a particular virtual stereo camera standpoint in a 3D-scene, based on available data of the 3D-scene. When the left eye image and the right eye image are viewed in combination, a viewer thereof perceives the 3D-scene as a 3D-image from the particular virtual stereo camera standpoint.

So, rendering according to the present invention can in fact be regarded as producing, by means of a virtual stereo camera, image data representing a stereoscopic view of the 3D-scene from a perspective that corresponds to the particular position of the virtual stereo camera relative to the 3D-scene. The virtual stereo camera then has its position at the position of the eyes of the viewer, with a left virtual camera at a left eye of the viewer and a right virtual camera at a right eye of the viewer. Consequently, movement of the viewer's head in the real world then causes the virtual stereo camera to move relative to the 3D-scene. A rendering module then continuously creates subsequent stereoscopic pairs of left eye images and right eye images from a moving standpoint of the virtual stereo camera. Tracking eye position then comes down to determining a virtual stereo camera position relative to the 3D-scene, so as to provide ‘recordings’ by the virtual stereo camera that can be displayed as a stereoscopic image.

In the context of the invention, by a “3D-scene” is meant a certain environment that is shaped in three dimensions, comprising one or more elements of which one or more properties are known, such as a property selected from the group of shape, dimensions, surface orientations, surface properties, relative position (e.g. with respect to other elements) and physical behavior. Behavior of incident light and/or sound in the 3D-scene may also be known, leading to e.g. occurrence of shadows and surface reflections in a rendered image. A 3D-scene is usually a virtual environment, but may also be a (recorded) real environment.

In the context of the invention, the term “3D-scene data” refers to information representing a 3D-scene, such as 3D-characteristics of elements of the 3D-scene and information on how these elements relate to each other in the 3D-scene (a 3D-mapping of the 3D-scene). 3D-scene data may include data on one or more properties of a scene element selected from the group of shape, dimensions, surface orientations, surface properties, relative position (e.g. with respect to other elements) and physical behavior. In the method of the invention, 3D-scene data are used to generate a stereoscopic image of the 3D-scene that corresponds to a particular viewpoint relative to the 3D-scene, a process that is known as ‘rendering’. Such rendering may be performed for virtually any desired viewpoint of the scene. The rendered stereoscopic image can then be displayed on the autostereoscopic display device wherein it is perceived as a 3D-image from the particular viewpoint.

The 3D-scene data may be stored in a memory part associated with the autostereoscopic display device or it may be generated real-time, for example by inputting a live recording (typically of the real world) to the autostereoscopic display device. It may also be combination of both, for example when a viewer or another person makes live modifications to stored 3D-scene data.

In the present description, it is stated that latency of an autostereoscopic display device is or may be compensated for, typically by extrapolating historical viewing positions to the future and by rendering stereoscopic images by using such extrapolated values. This means that the apparent latency is reduced here, which is the latency as perceived by the viewer. The latency of the autostereoscopic display device itself remains unaffected with such methods.

Methods according to the present invention apply the known principle of displaying a stereoscopic image of a 3D-scene to a viewer, wherein the displaying is performed in such way that the viewer experiences the 3D-scene with a perspective that corresponds to his viewing position relative to the 3D-scene. Moreover, when the viewer changes his position relative to the 3D-scene, then such changes are reflected in a new stereoscopic image that is displayed subsequently. In this way, a viewer who moves laterally relative to the display device can for example experience motion parallax of the 3D-scene when the 3D-scene is fixed to a screen of the autostereoscopic display device (objects on the foreground appear to move to a larger extent than objects in the background). He will also be able to inspect a displayed 3D-object from different angles, which causes him to perceive the so-called ‘look-around effect’. In an ideal situation, as is pursued by the present invention, an experienced motion parallax of the 3D-scene is in line with motion parallax of the real world. When, for example, a virtual object is positioned onto a real object that is present between the screen and the viewer, both objects do not move relative to one another upon inspection from different angles.

For experiencing a 3D-scene with a perspective that corresponds to a viewer's viewing position, it is however not necessary that the 3D-scene is fixed to the screen. In some embodiments, the 3D-scene is fixed to the real world and not affected by screen movement relative to the real world; the screen then acts as a virtual window or a moveable frame through which the 3D-scene is viewed.

In other embodiments, the 3D-scene is movable relative to the screen, allowing a viewer to inspect a 3D-scene from different angles whilst sitting still in front of the screen. In such case, the viewer may have a joystick, mouse or other input method to control the movement of the 3D-scene, such as its rotation or translation relative to the screen.

Known methods that apply the principle of adapting a 3D-scene to a viewer's viewing position track pupil position so that each eye can be accurately presented with the intended image information. All display devices wherein such methods are applied, suffer however from noticeable incorrect stereoscopic image rendering when pupil movement is very fast. This means that the time it takes for a pupil to arrive at a new position that is remote enough to cause a noticeable incorrect display of the image, is shorter than the latency of the display device. Such latency is also known as the response time of the display device, which is the time delay between the point in time where a viewer's pupil has taken a new position and the point in time where the eyes see a displayed image where account has been taken of the new pupil position.

With a given latency, relatively slow pupil movement does not give rise to a noticeable incorrect display of the image, for example pupil movement due to normal head movement or when the pupil is in a so-called smooth pursuit mode.

Relatively fast pupil movement, on the other hand, cannot timely be accounted for. Such speedy pupil movement is almost always caused by saccades, and not by common movement of the head as a whole. Saccades generally occur too fast for an autostereoscopic display device to timely take them into account.

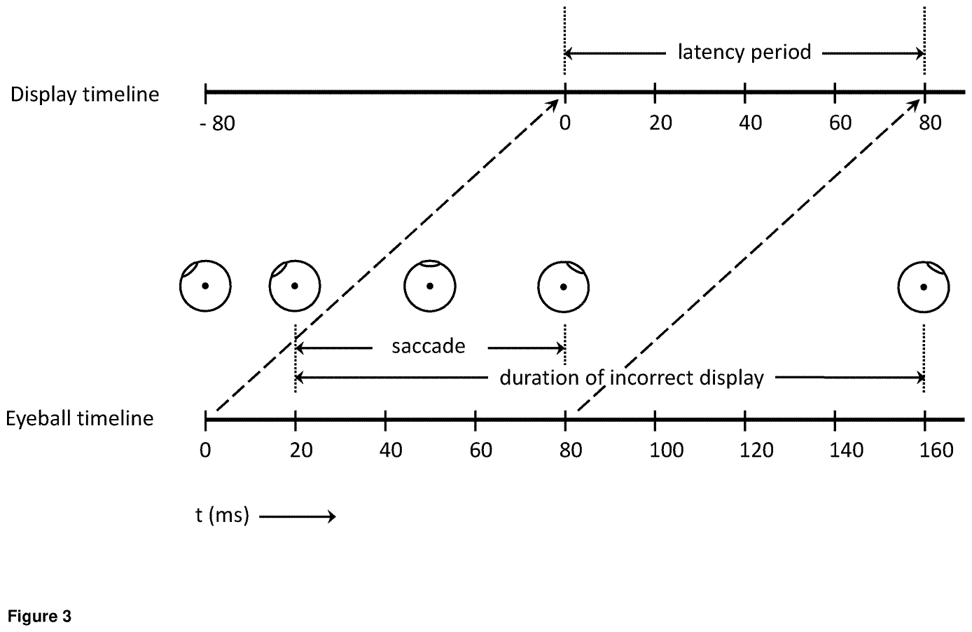

This is illustrated by an example situation in FIG. 3, which displays an eyeball timeline reflecting eyeball orientations at moments t_{eyeball} (bottom timeline in the Figure) and a display timeline reflecting stereoscopic image display at moments t_{display} (top timeline the Figure). The display timeline lags behind the eyeball timeline due to a system latency of 80 ms. Between both timelines, a schematical top view of an eyeball including a pupil is provided at certain intervals along the eyeball timeline, wherein different pupil positions illustrate the eye's varying orientation over time (such as a saccade occurring between 20 and 80 ms).

In this particular example, the display timeline is delayed for 80 ms with respect to the eyeball timeline. The delay is a result of latency of the autostereoscopic display device. This delay is 80 ms and has the effect that an eyeball orientation at t_{eyeball}=0 ms is used for the rendering of an image that appears to a viewer only at t_{eyeball}=80 ms (corresponding to t_{display}=0 ms). A 60 ms saccade of the eye that ends at t_{eyeball}=80 ms is not accounted for within these 80 ms. So, at t_{eyeball}=80 ms the eye has an orientation that is not accounted for in the image that is rendered at that time (t_{display}=0 ms). At the same time, the eyeball orientation at t_{eyeball}=80 ms is used for the rendering of an image that appears to a viewer at 160 ms (t_{display}=80 ms). So, only 80 ms after completion of the saccade, the viewer will see an image that is in agreement with the eyeball orientation resulting from the saccade (supposing no new saccade has occurred).

Moreover, during the saccade itself, the image is neither in agreement with the eyeball orientation (the disagreement builds up from none at t_{eyeball}=20 ms to a maximum at t_{eyeball}=80 ms). So, during the t_{eyeball} period of 20-160 ms, the viewer will be presented with an image that is not rendered correctly.

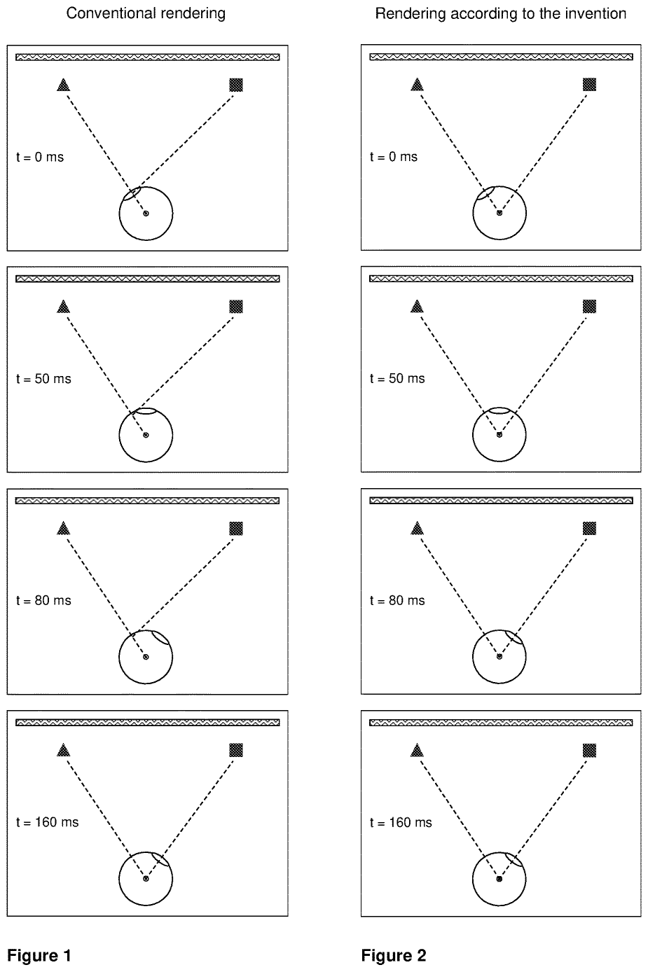

The incorrect rendering as a result of pupil position that is not (timely) accounted for is visualized in FIG. 1. Each of the four drawings represents a top view of a setting wherein an image is rendered on the viewer's pupil, each image comprising a triangular object and a square object which a viewer perceives as being in front of a screen of the autostereoscopic display device (an eyeball with a pupil is shown at the bottom of each picture, a screen viewed by the eyeball is shown at the top of each picture). The four drawings correspond to different points in time of one and the same setting wherein a saccade occurs. These points in time correspond to the events that are visualized in the eyeball timeline of FIG. 3. The eyeball is initially directed at the triangle (t_{eyeball}=0 ms). When the eyeball is directed at the square at t_{eyeball}=80 ms (just after completion of the saccade), it can be seen that the rendering of the square at that time is still based on the pupil position at t_{eyeball}=0 ms. Only at t_{eyeball}=160 ms, the rendered image is rendered with the correct pupil position.

Rather than aiming at combatting the latency itself (i.e. true latency reduction), for example by improving the hardware or software of the display device, the present invention provides an approach wherein image rendering is performed independently of pupil position with respect to the head, taking the occurrence of saccades out of play. In this alternative approach, rendering is performed on a rendering spot in each of the viewer's eyes with a position that is (largely) fixed with respect to the head as a whole. Thus, the rendering spot in each eye has a position that is independent on whether an eye rotates in the eye socket. According to the invention, each of the two rendering spots is located at the center of the respective eyeball, or close thereto (typically within 5.0 mm of the center).

According to common theory, the conventional rendering of stereoscopic images on the pupils themselves offers the best user perception of a 3D-scene in the sense that it is stable and fixed to the real world. This means that the position of the pupils as acquired by the eye tracker is taken as the viewing position for rendering the stereoscopic image. Surprisingly, however, a deviation therefrom as applied in the present invention (namely by choosing a rendering spot at or near the center of the eyeball) appeared to barely affect the viewer's perception of 3D-scene position with respect to the real world. This may well be due to the fact that the deviation applied by the present invention has no significant influence on light rays that travel through the lens via the normal to the lens or via a direction that is slightly deviated from the normal, as these rays do not (or barely) undergo refraction. And it is exactly this direction that is most important to the viewer, as his gaze will predominantly be in the direction of these largely unrefracted rays. Although all directions other than the normal direction theoretically bring along some incorrect rendering, it is acknowledged that also directions close to the normal, say those within 10° of the normal, do not lead to a noticeable image deterioration by the user. Only peripheric areas that are truly remote from the point of gaze of the viewer may lead to substantial errors in the 3D-scene position with respect to the real world, but a viewer will normally not perceive these, since the human eye does not have many light receptors in the periphery of his field of view. Therefore, the periphery is perceived with much less detail than the region that the user is seeing with a more central part of his field of view that has more light receptors.

A beneficial effect of this way of incorrect rendering in areas that are peripheric to a particular gaze, is that this incorrect rendering immediately vanishes when the gaze is directed at these areas after a saccade (assuming that change in pupil position due to movement of the head as a whole during the saccade is small compared to the change in pupil position due to the saccade). This is because rendering according to a method of the invention is performed on a rendering spot that is in the center of the eyeball (or close thereto). Whatever the orientation of the eye, rays that travel normal to the eye lens always pass through this rendering spot—and so do rays that are part of the viewer's gaze. In other words, all areas of an image that is rendered according to the invention are all rendered simultaneously as if the viewer gazes at all of them simultaneously. Every new point of gaze following a saccade is therefore automatically rendered correctly. After a saccade, the user does not perceive a change of rendering position after the actual display latency, because the rendering position is not affected by the saccade. This is what actually causes that saccades are taken out of play by the method of the invention without negatively affecting image perception at the point of gaze.

The rendering according to the invention is visualized in FIG. 2 in a way that is analogous to that of FIG. 1. Each of the four drawings represents a top view of a setting wherein an image is rendered on the viewer's eyeball center (the rendering spot), each image comprising a triangular object and a square object which a viewer perceives as being in front of the screen (an eyeball with a pupil is shown at the bottom of each picture, a screen viewed by the eyeball is shown at the top of each picture). The four drawings correspond to different points in time of one and the same setting wherein a saccade occurs. These points in time correspond to the events that are visualized in the eyeball timeline of FIG. 3. The eyeball is initially directed at the triangle (t_{eyeball}=0 ms). When the eyeball is directed at the square at t_{eyeball}=80 ms (just after completion of the saccade), it can be seen that the rendering of the square at that time is based on the rendering spot in the center of the eyeball, which remains at the same position upon eyeball rotation. In other words, eyeball rotation does not incur an incorrect rendering at the point of gaze (the square). It can however be seen that the rendering of the square at t_{eyeball}=0 ms is indeed incorrect. As explained above, this incorrect rendering occurs in the periphery of the field of view and is therefore preferable over an incorrect rendering at the point of gaze.

Thus, rendering occurs at two rendering spots, the locations of which are defined relative to the head as a whole. There is a left rendering spot associated with the left eye and a there is a right rendering spot associated with the right eye, each rendering spot falling within the transparent inner part of the respective eyeball, the vitreous body. Each rendering spot itself is not specifically defined or demarcated by a particular physical feature of the viewer. It is a point in a volume element that is centered around a center of rotation of the respective eyeball. Each rendering spot has a fixed position with respect to the viewer's head as a whole and is located at a center of rotation of the respective eyeball (or at a distance therefrom of 8.0 mm or less).

It is recognized that the center of rotation of an eyeball may be slightly variable relative to the eye socket (and thus to the head), depending on the actual eyeball orientation, as an eye and/or eye socket does not necessarily form a perfect sphere. So in practice, an eye may have a plurality of rotation centers. Since any variation in their position is very small, any effects thereof will not be noticeable by the viewer, so the perceived quality of the displayed stereoscopic image will be the quality as if a method of the invention would be applied taking account of a variable center of rotation. Accordingly, in case a plurality of rotation centers exists for an eye, any one of them may be chosen for the purpose of defining a rendering spot.

The rendering spots are typically located within 8.0 mm of such center of rotation. Preferably, the rendering spots are located at a shorter distance, for example at a distance from the center of rotation of their respective eyeball of 7.0 mm or less, 6.0 mm or less, 5.0 mm or less, 4.0 mm or less, 3.0 mm or less, 2.0 mm or less or 1.0 mm or less. In a preferred embodiment, their positions coincide with the center of rotation of their respective eyeball.

For the rendering, the position of the left rendering spot relative to the autostereoscopic display device and the position of the right rendering spot relative to the autostereoscopic display device are used. These positions may be obtained by (1) tracking both eyes of a particular viewer, after an initial determination of the position of the rendering spot in the eye (or relative to the pupil) of the viewer; or (2) by tracking one or more other facial characteristics of a particular viewer, when the positions of these characteristics relative to the left rendering spot and the right rendering spot are known for the viewer, for example by an initial determination.

Therefore, in an embodiment, the position of the left rendering spot relative to the autostereoscopic display device and the position of the right rendering spot relative to the autostereoscopic display device are determined by the steps of
1) identifying one or more facial characteristics of the viewer other than the left rendering spot and the right rendering spot;
2) determining the position of the left rendering spot and the right rendering spot relative to the one or more facial characteristics;
3) determining the position of the facial characteristic relative to the autostereoscopic display device;
4) using the positions determined in steps 2) and 3) to determine the position of the left rendering spot relative to the autostereoscopic display device and/or the position of the right rendering spot relative to the autostereoscopic display device.

A facial characteristic that may be used in this method is for example selected from the group of nose, mouth, ears, wrinkles and eyebrows.

A method of the invention makes use of an autostereoscopic display device. Such device may be a device that is largely stationary in the real world during its use, such as a desktop device or a wall-mounted device. For example, the autostereoscopic display device is a television, a (desktop) computer with a monitor, a laptop, or a cinema display system. It may also be a portable device such as a mobile phone, a tablet or a game console.

In a method of the invention, the autostereoscopic display device is preferably a device comprising a pixel array lined with a lenticular lens that is capable of directing pixel output (i.e. light) belonging to a left eye image specifically to a left eye of a viewer and capable of directing pixel output (i.e. light) belonging to a right eye image specifically to a right eye of a viewer. The combined pixel output of the pixels in the pixel array forms the output of the display as a whole, i.e. the display output.

Such autostereoscopic display device preferably also comprises a tracking system that is configured to determine the position of the left rendering spot of a viewer and the right rendering spot of a viewer relative to the autostereoscopic display device. These obtained position data are then used to render the stereoscopic image and control the pixels.

Therefore, in an embodiment, the method of the invention comprises an autostereoscopic display device comprising
a left rendering spot and right rendering spot tracking system configured to track the position of the left rendering spot and the position of the right rendering spot relative to the autostereoscopic display device; and
a display portion configured to display a left eye image to be viewed by a left eye of the viewer and a right eye image to be viewed by a right eye of the viewer, the display portion comprising
   an array of display pixel elements for producing a display output; and
   a lenticular device provided over the array wherein the lenticular device comprises lenticular lens areas which are capable of directing the display output from different display pixel elements to different spatial positions within a field of view of the autostereoscopic display device to allow a display of a stereoscopic image that is composed of a left eye image and a right eye image.

Typically, such autostereoscopic display device also comprises a rendering module configured to render a stereoscopic image from 3D-scene data, taking into account the position of the left rendering spot relative to the autostereoscopic display device and the position of the right rendering spot relative to the autostereoscopic display device.

The data on the position of the left rendering spot and the right rendering spot relative to the autostereoscopic display device can also serve as input for weaving the left eye image and the right eye image to the array of display pixel elements, i.e. selecting the correct display pixel elements for the display of both images so that the stereoscopic image is presented to the viewer as intended. Accordingly, the displaying of the rendered stereoscopic image in a method of the invention may comprise weaving the left eye image and the right eye image to the array of display pixel elements, wherein the weaving comprises
selecting display pixel elements that produce pixel output for the left eye image and selecting display pixel elements that produce pixel output for the right eye image, taking into account the position of the left rendering spot relative to the autostereoscopic display device and of the position of the right rendering spot relative to the autostereoscopic display device, respectively;
controlling the selected display pixel elements accordingly to display, to the viewer, the stereoscopic image.

Usually, a method of the invention is performed a plurality of times in a sequence. In this way, a new position of the viewer relative to the autostereoscopic display device can be accounted for, allowing a viewer to perceive motion with respect to the displayed 3D-scene. For example, the method is repeated at least 10 times, at least 100 times, at least 1,000 times, at least 10,000 times, at least 100,000 times or at least 1,000,000 times.

Re-rendering the stereoscopic image for each new position of the viewer relative to the 3D-scene gives the viewer the impression that he truly moves relative to the 3D-scene (or the 3D-scene truly moves relative to him when he can control the position and orientation of the 3D-scene relative to a screen of the autostereoscopic display device), especially when the re-rendering is performed at a suitable frequency. For a realistic viewing experience, the rendering usually occurs at a frequency that is at least 10 times per second. Preferably, the frequency is at least 20 times per second, more preferably at least 30 times per second, and even more preferably at least 50 times per second. For example, it is in the range of 50 -250 times per second, in the range of 55-150 times per second or in the range of 60-120 times per second. It may in particular be 60 Hz, 120 Hz, 144 Hz, 165 Hz or 240 Hz. Preferably, it is at the same frequency as a refresh rate of the screen itself.

As highlighted above, the method of the invention takes saccades out of play. This basically means that when (1) a first stereoscopic image is displayed by an autostereoscopic display device and (2) a saccade occurs thereafter but before a second, subsequent, stereoscopic image is displayed, then the second stereoscopic image does not differ from the first stereoscopic image. In other words, an autostereoscopic display device that performs a method of the invention does not respond to a saccade. Moreover, after a saccade has occurred, the viewer immediately experiences a good rendering of the stereoscopic image at the point of gaze.

Accordingly, the rendering of a stereoscopic image in a method of the invention only takes into account the movement of the head as a whole (and not the movement of the eyeballs relative to the rest of the head). Such movement is not as a fast as pupil movement due to a saccade and can be predicted using methods known in the art. Input for such predictions is formed by historic head positions and orientations, as well as speed and/or acceleration of the left rendering spot and the right rendering spot relative to the autostereoscopic display device. With such predictions, the apparent latency of the autostereoscopic display device can be reduced substantially (or, in other words, the latency of the autostereoscopic display device can substantially be compensated for), leading to an improved viewing experience of the viewer. Therefore, the method of the invention may comprise reducing the apparent latency of the autostereoscopic display device (or, in other words, it may comprise compensating the latency of the autostereoscopic display device).

In doing so, stereoscopic images are rendered more accurately in the area within the viewer's gaze and comprise less jitter, as compared to stereoscopic images that are rendered by using pupil position rather than the rendering spot according to the invention.

In particular, the method may comprise the steps of
acquiring data on the speed and/or acceleration of the left rendering spot and/or the right rendering spot relative to the autostereoscopic display device;
using the acquired data to predict the position of the left rendering spot relative to the autostereoscopic display device and the position of the right rendering spot relative to the autostereoscopic display device;
using the predicted positions for the rendering of the stereoscopic image from the 3D-scene data and for displaying it to the viewer;
optionally using the predicted positions to weave the left eye image and the right eye image to the array of display pixel elements.

It is in some cases not necessary to predict the position of both the left rendering spot and the right rendering spot. Since both spots have a fixed distance, it may suffice to predict the speed and/or acceleration of only one of them when (1) head orientation is known and can be accounted for; and (2) the relative positioning of the two rendering spots in the head is known.

It is known in the art how to compensate for latency of an autostereoscopic display device. For example, this may be performed by using a history of a plurality of left and right viewing positions of a viewer, and fitting a model to these viewing positions in order to extrapolate the positions at a future time.

The 3D-scene may in principle be any imaginable 3D-scene. Since a 3D-scene needs to be capable of being perceived from different viewing positions and with perspectives that correspond to these viewing positions, a 3D-mapping of the 3D-scene needs to be available that entails more than just one stereoscopic image of the 3D-scene from one particular viewpoint. For this reason, the 3D-scene data preferably represents an artificially-made 3D-scene, as such scene usually comprises an extensive or complete 3D-mapping of the 3D-scene-and such 3D-mapping in principle allows the generation of a stereoscopic image from any viewpoint (i.e. from any virtual stereo camera position).

It is, in principle, however also possible that the 3D-scene data represents a 3D-scene in the real world. Such real scene is for example recorded from a plurality of different camera positions. The 3D-scene data that results from recordings from the different camera positions allows that the real scene is capable of being perceived with a perspective that corresponds to different viewing positions (i.e. it allows the generation of a stereoscopic image from more than viewpoint). So, also in this situation, a stereoscopic image may be generated from any viewpoint (i.e. from any virtual stereo camera position).

The invention further relates to an autostereoscopic display device configured to perform a method according to the invention (i.e. one of the methods as described hereabove).

In a preferred embodiment, the autostereoscopic display device comprises a latency compensating module (or, in other words, an apparent latency reducing module) configured to predict the position of the left rendering spot relative to the autostereoscopic display device and the position of the right rendering spot relative to the autostereoscopic display device, wherein the rendering module is configured to use the predicted positions for the rendering of the stereoscopic image.
in another embodiment, the autostereoscopic display device is configured to determine the position of the left and right rendering spot relative to the autostereoscopic display device by determining the position of one or more facial characteristics of the viewer that have a known position relative to both rendering spots. Accordingly, an autostereoscopic display device of the invention may
be configured to determine the position of one or more facial characteristics of the viewer, other than the left rendering spot and the right rendering spot, relative to the autostereoscopic display device; and
comprise a memory comprising stored data representing the position of the left rendering spot and the right rendering spot relative to the one or more facial characteristics.

An autostereoscopic display device of the invention usually comprises a weaving module that is configured to weave the left eye image and the right eye image to the array of display pixel elements by
selecting display pixel elements that produce pixel output for the left eye image and selecting display pixel elements that produce pixel output for the right eye image;
controlling the selected display pixel elements accordingly to display, to the viewer, the stereoscopic image.

In a preferred embodiment, the position of the left rendering spot relative to the autostereoscopic display device and of the position of the right rendering spot relative to the autostereoscopic display device are taken into account for selecting the display pixel elements that produce pixel output for the left eye image and the right eye image.

An autostereoscopic display device according to the invention may be a device that is largely stationary in the real world during its use, such as a desktop device or a wall-mounted device. For example, the autostereoscopic display device is a television, a (desktop) computer with a monitor, a laptop, or a cinema display system. It may also be a portable device such as a mobile phone, a tablet or a game console.

1-15. (canceled)

16. A method for operating an autostereoscopic display device, the method comprising:
providing three-dimensional scene data representing a three-dimensional scene;
rendering a stereoscopic image from the three-dimensional scene data by creating a left eye image and a right eye image, the left eye image being configured to be viewed by a left eye of a viewer, the right eye image being configured to be viewed by a right eye of the viewer;
defining a position of a left rendering spot corresponding to the left eye of the viewer relative to the autostereoscopic display device, the left rendering spot having a fixed position with respect to a head of the viewer, the left rendering spot being within 5 mm from a center of rotation of the left eye;
defining a position of a right rendering spot corresponding to the right eye of the viewer relative to the autostereoscopic display device, the right rendering spot having a fixed position with respect to the head of the viewer, the right rendering spot being within 5 mm from a center of rotation of the right eye; and
rendering the stereoscopic image as a rendered stereoscopic image, based at least in part on the position of the left rendering spot relative to the autostereoscopic display device and the position of the right rendering spot relative to the autostereoscopic display device. ; and

17. The method of claim 16, wherein:
the left rendering spot is located within 3 mm from the center of rotation of the left eye; and
the right rendering spot is located within 3 mm from the center of rotation of the right eye.

18. The method of claim 16, wherein defining the position of the left rendering spot comprises:
identifying one or more facial characteristics of the viewer other than the left rendering spot;
determining a first position of the left rendering spot relative to the one or more facial characteristics;
determining a second position of the one or more facial characteristics relative to the autostereoscopic display device; and
determining the position of the left rendering spot relative to the autostereoscopic display device based at least in part on the first position and the second position.

19. The method of claim 16, wherein defining the position of the right rendering spot comprises:
identifying one or more facial characteristics of the viewer other than the right rendering spot;
determining a first position of the right rendering spot relative to the one or more facial characteristics;
determining a second position of the one or more facial characteristics relative to the autostereoscopic display device; and
determining the position of the right rendering spot relative to the autostereoscopic display device based at least in part on the first position and the second position.

20. The method of claim 16, wherein the autostereoscopic display device comprises:
a tracking system configured to track the position of the left rendering spot relative to the autostereoscopic display device and the position of the right rendering spot relative to the autostereoscopic display device; and
a display portion comprising:
an array of display pixel elements configured to produce a display output; and
a lenticular device disposed over the array, the lenticular device comprising lenticular lens areas configured to direct the display output from different display pixel elements to different spatial positions within a field of view to display the stereoscopic image.

21. The method of claim 20, wherein displaying the rendered stereoscopic image comprises weaving the left eye image and the right eye image to the array of display pixel elements by:
selecting first display pixel elements configured to produce pixel output for the left eye image based on the position of the left rendering spot, selecting second display pixel elements configured to produce pixel output for the right eye image based on the position of the right rendering spot; and
controlling the first display pixel elements and the second display pixel elements to display the stereoscopic image.

22. The method of claim 16, further comprising repeating the method at least 100 times.

23. The method of claim 16, further comprising repeating the method at a frequency between 55 repetitions per second and 150 repetitions per second.

24. The method of claim 16, further comprising compensating for latency of the autostereoscopic display device.

25. The method of claim 16, further comprising:
acquiring data regarding at least one of speed or acceleration of at least one of the left rendering spot and the right rendering spot relative to the autostereoscopic display device;
predicting the position of the left rendering spot and the position of the right rendering spot relative to the autostereoscopic display device using the acquired data; and
rendering and displaying the stereoscopic image based at least in part on the predicted position of the left rendering spot and the predicted position of the right rendering spot.

26. The method of claim 16, wherein the three-dimensional scene data represents an artificial three-dimensional scene.

27. The method of claim 16, wherein the three-dimensional scene data represents a real-world three-dimensional scene.

28. An autostereoscopic display device configured to display a stereoscopic image of a three-dimensional scene to a viewer, the autostereoscopic display device comprising:
a tracking system configured to track a position of a left rendering spot corresponding to a left eye of the viewer relative to the autostereoscopic display device, the left rendering spot having a fixed position with respect to a head of the viewer, the left rendering spot being located within 20 mm of a center of rotation of the left eye, the tracking system being configured to track a position of a right rendering spot corresponding to a right eye of the viewer relative to the autostereoscopic display device, the right rendering spot having a fixed position with respect to the head of the viewer, the right rendering spot being located with 20 mm of a center of rotation of the right eye;
a display portion configured to display a left eye image to the left eye of the viewer and a right eye image to the right eye of the viewer, the display portion comprising:
an array of display pixel elements configured to produce a display output; and
a lenticular device disposed over the array, the lenticular device comprising lenticular lens areas configured to direct the display output from different display pixel elements to different spatial positions within a field of view to display the stereoscopic image; and
rendering circuitry configured to render the stereoscopic image from three-dimensional scene data based at least in part on the position of the left rendering spot relative to the autostereoscopic display device and the position of the right rendering spot relative to the autostereoscopic display device, the stereoscopic image representing the three-dimensional scene from a viewing position of the viewer relative to the autostereoscopic display device.

29. The autostereoscopic display device of claim 28, further comprising:
latency compensation circuitry configured to predict the position of the left rendering spot relative to the autostereoscopic display device and the position of the right rendering spot relative to the autostereoscopic display device, the rendering circuitry being configured to render the stereoscopic image based at least in part on the predicted position of the left rendering spot relative to the autostereoscopic display device and the predicted position of the right rendering spot relative to the autostereoscopic display device.

30. The autostereoscopic display device of claim 28, further comprising:
a processor configured to determine a position of one or more facial characteristics of the viewer, other than the left rendering spot and the right rendering spot, relative to the autostereoscopic display device; and
a memory storing data representing a position of the left rendering spot relative to the one or more facial characteristics and a position of the right rendering spot relative to the one or more facial characteristics.

31. The autostereoscopic display device of claim 28, further comprising:
weaving circuitry configured to weave the left eye image and the right eye image to the array of display pixel elements by:
selecting first display pixel elements configured to produce pixel output for the left eye image based on the position of the left rendering spot;
selecting second display pixel elements configured to produce pixel output for the right eye image based on the position of the right rendering spot; and
controlling the first display pixel elements and the second display pixel elements to display the stereoscopic image to the viewer.
